(19) United States
(12) Patent Application Publication
(10) Pub. No.: US 2015/0224702 A1
(43) Pub. Date: Aug. 13, 2015

(54) PATTERN INSPECTION MEMBER, PATTERN INSPECTION METHOD, AND PATTERN INSPECTION APPARATUS

(71) Applicant: KABUSHIKI KAISHA TOSHIBA, Tokyo (JP)

(72) Inventors: MASAFUMI ASANO, Yokohama-shi (JP); Seiji MORITA, Tokyo (JP)

(21) Appl. No.: 14/294,597

(22) Filed: Jun. 3, 2014

(30) Foreign Application Priority Data
Feb. 13, 2014 (JP) 2014-025740

(51) Int. Cl. B29C 59/00

(52) U.S. Cl. CPC B29C 59/002; B29K 2083/00

(57) ABSTRACT

According to one embodiment, a pattern inspection member is a pattern inspection member to which a pattern provided in an inspection object is transferred. The pattern inspection member includes a component pertaining to photosensitivity or thermosensitivity, a component pertaining to stretching and a component pertaining to feature retention of the pattern. The component pertaining to photosensitivity or thermosensitivity includes a photosensitive resin or a thermosensitive resin. The component pertaining to stretching includes a thermoplastic resin including no cyclic structure. The component pertaining to feature retention of the pattern includes a thermoplastic resin including a cyclic structure.

### CROSS-REFERENCE TO RELATED APPLICATIONS

This application is based upon and claims the benefit of priority from Japanese Patent Application No. 2014-025740, filed on Feb. 13, 2014; the entire contents of which are incorporated herein by reference.

### FIELD

Embodiments described herein relate generally to a pattern inspection member, a pattern inspection method, and a pattern inspection apparatus.

### BACKGROUND

In the manufacturing of semiconductor devices, the imprint technique may be used to form a pattern. For instance, a liquid resin material is dropped on a semiconductor substrate. An imprint template (also called imprint mold, mold and so on) with a pattern formed therein is pressed against the resin material. The resin material is cured by irradiation with ultraviolet radiation. Thus, a transfer target part in which the pattern is transferred is formed on the semiconductor substrate.

If a defect exists in the pattern formed in the imprint template, the defect is transferred to the transfer target part. Thus, the pattern formed in the imprint template is subjected to defect inspection.

Defect inspection of the pattern formed in the imprint template can be performed by an optical defect inspection apparatus using a short wavelength laser (e.g., a solid-state SHG (second harmonic generation) laser with a wavelength of 193 nm).

However, in the inspection by the optical defect inspection apparatus, the detectable defect size is substantially 20 nm or more due to the optical resolution limit.

Thus, there is demand for the development of a technique capable of detecting fine defects.

### BRIEF DESCRIPTION OF THE DRAWINGS

FIG. 1 is a schematic sectional view for illustrating an inspection object 1;

FIG. 2 is a schematic process sectional view for illustrating the process of transfer;

FIG. 3A is a schematic sectional view for illustrating a pattern inspection member 100 with a transferred pattern;

FIG. 3B is a schematic plan view for illustrating the pattern inspection member 100 with a transferred pattern;

FIG. 4A is a schematic sectional view for illustrating a state in which the pattern inspection member 100 with a transferred pattern is stretched;

FIG. 4B is a schematic plan view for illustrating the state in which the pattern inspection member 100 with a transferred pattern is stretched;

FIG. 5 is a layout diagram for illustrating the pattern inspection apparatus 300; and

FIG. 6 is a schematic perspective view for illustrating the stretching section 303.

### DETAILED DESCRIPTION

In general, according to one embodiment, a pattern inspection member is a pattern inspection member to which a pattern provided in an inspection object is transferred. The pattern inspection member includes a component pertaining to photosensitivity or thermosensitivity, a component pertaining to stretching and a component pertaining to feature retention of the pattern. The component pertaining to photosensitivity or thermosensitivity includes a photosensitive resin or a thermosensitive resin. The component pertaining to stretching includes a thermoplastic resin including no cyclic structure. The component pertaining to feature retention of the pattern includes a thermoplastic resin including a cyclic structure.

Embodiments will now be illustrated with reference to the drawings. In the drawings, similar components are labeled with like reference numerals, and the detailed description thereof is omitted appropriately.

### First Embodiment

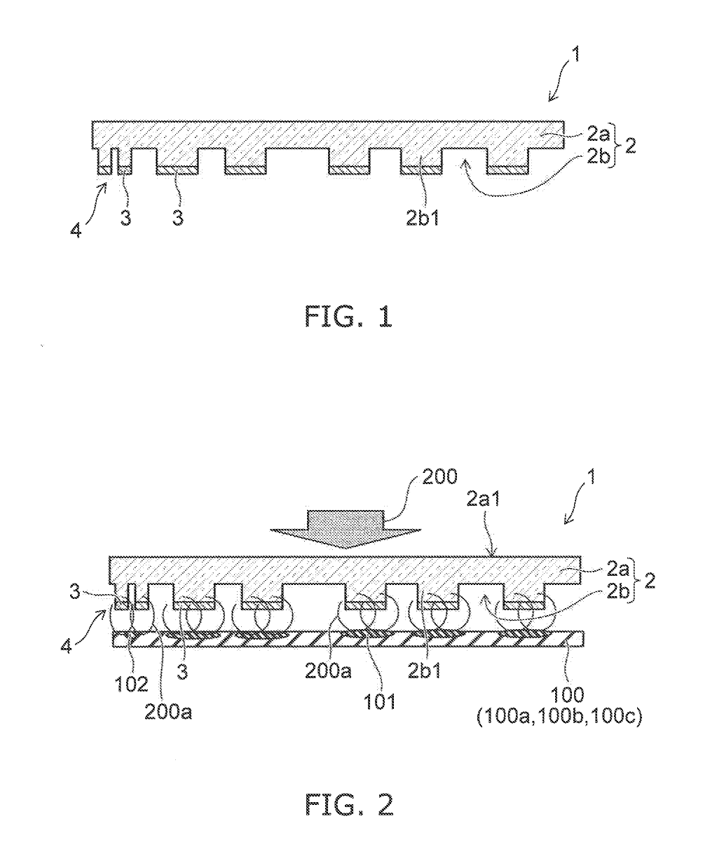

FIG. 1 is a schematic sectional view for illustrating an inspection object 1.

FIG. 2 is a schematic process sectional view for illustrating the process of transfer.

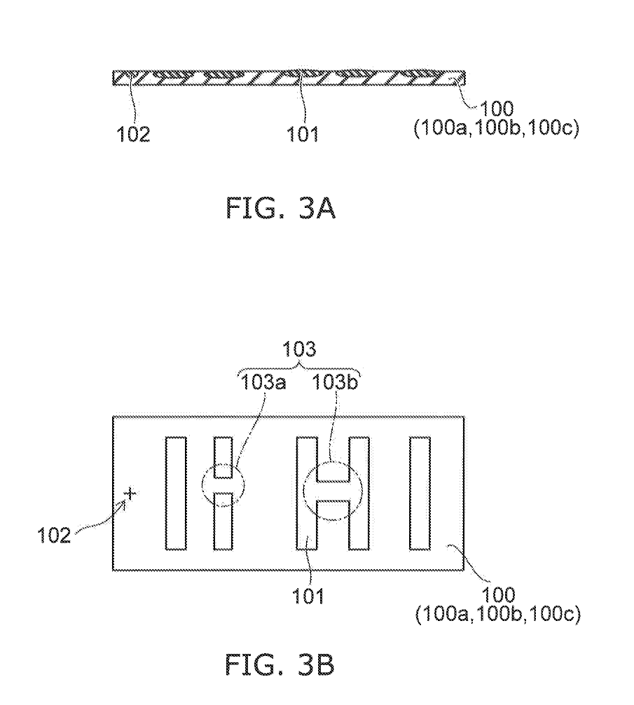

FIG. 3A is a schematic sectional view for illustrating a pattern inspection member 100 with a transferred pattern.

FIG. 3B is a schematic plan view for illustrating the pattern inspection member 100 with a transferred pattern.

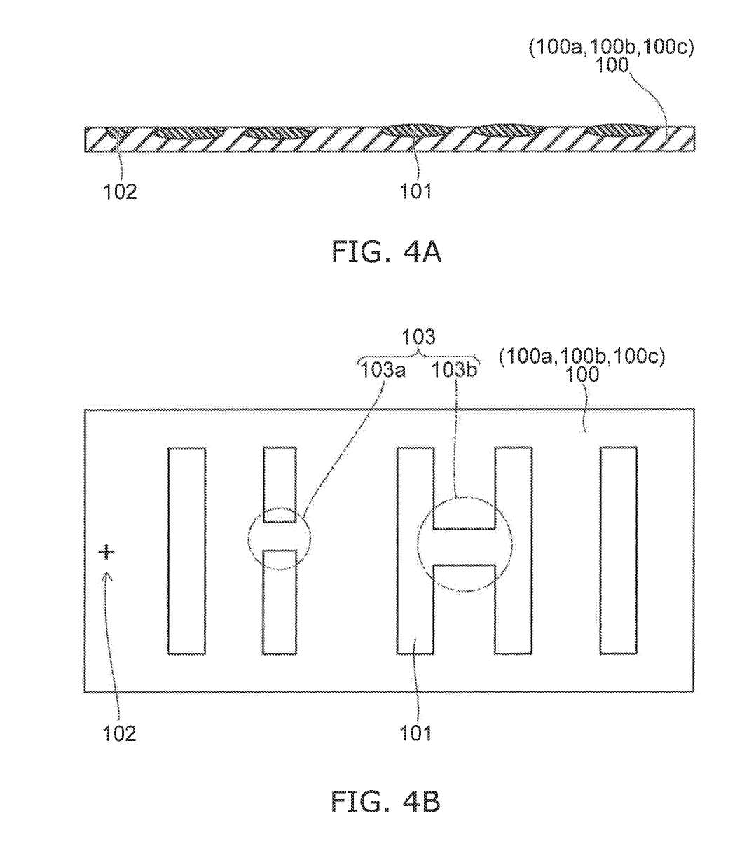

FIG. 4A is a schematic sectional view for illustrating a state in which the pattern inspection member 100 with a transferred pattern is stretched.

FIG. 4B is a schematic plan view for illustrating the state in which the pattern inspection member 100 with a transferred pattern is stretched.

First, the inspection object 1 is described.

As shown in FIG. 1, the inspection object 1 includes an imprint template 2, a metal film 3, and a mark part 4.

The imprint template 2 includes a base part 2a and a pattern part 2b.

The base part 2a is shaped like a plate. When the imprint template 2 is attached to an imprint apparatus, the base part 2a is held by the imprint apparatus.

The pattern part 2b is provided on one surface of the base part 2a. The pattern part 2b can be configured to include a plurality of protrusions 2b1 projected from one surface of the base part 2a. The protrusions 2b1 are pressed against e.g. a transfer target part (e.g., resist) on a semiconductor substrate (wafer). Thus, a desired pattern (such as a circuit pattern of a semiconductor device) is transferred to the transfer target part.

The configuration of the pattern part 2b is not limited to e.g. the shape of the protrusion 2b1, the arrangement of the protrusions 2b1, and the number of protrusions 2b1 illustrated above. The configuration of the pattern part 2b can be appropriately modified in accordance with the pattern transferred to the transfer target part on the semiconductor substrate.

The base part 2a and the protrusion 2b1 can be formed from a material such as quartz.

Here, imprint templates 2 include a master template and a replica template.

The master template is a template for creating a replica template. The replica template is used in transferring a pattern to a transfer target part.

Repetitive transfer of the pattern gradually damages the pattern part 2b. Thus, the master template is used to create a plurality of replica templates, which are consumables.

The imprint template 2 may be either a master template or a replica template.

The metal film 3 is shaped like a film and provided so as to cover the top surface of the protrusion 2b1.

The metal film 3 can be a film based on chromium, a film based on chromium nitride, a film based on chromium oxide, or a laminated film of a combination thereof.

The metal film 3 is provided in order to generate near-field light 200a described later.

The metal film 3 can be provided on the imprint template 2 in order to perform pattern inspection of the imprint template 2. However, the hard mask used to form the protrusion 2b1 can be used instead.

For instance, the following process can be used in the case where the metal film 3 is used as a hard mask used to form the protrusion 2b1.

First, a film based on chromium or the like is formed on the surface of a plate-like blank based on quartz or the like.

The film based on chromium or the like is a film constituting a hard mask (metal film 3).

Next, an etching mask having a desired pattern is formed on the film based on chromium or the like.

Next, the etching mask is used to perform dry etching processing on the film based on chromium or the like. Thus, a hard mask is formed.

Next, the etching mask is removed.

Next, the hard mask is used to perform dry etching processing on the surface of the blank. Thus, a protrusion 2b1 is formed.

Accordingly, the inspection object 1 illustrated in FIG. 1 is formed. The inspection object 1 includes a metal film 3 (hard mask) covering the top surface of the protrusion 2b1, and an imprint template 2.

Next, pattern inspection of the inspection object 1 is performed.

Details on the pattern inspection will be described later. Subsequently, the hard mask (metal film 3) is removed by wet etching processing. Thus, an imprint template 2 is formed.

The mark part 4 is provided in order to transfer a reference mark 102 to the pattern inspection member 100.

The mark part 4 can be provided in the peripheral region surrounding the pattern region in which a plurality of protrusions 2b1 are provided.

The peripheral region is e.g. a region located on the scribe line (dicing line) of the semiconductor substrate when performing transfer using the imprint template 2.

The mark part 4 can be configured as e.g. a hole shaped like a cross, quadrangle or the like provided in the metal film 3.

Next, the pattern inspection member 100 is described.

As described later, the feature of the pattern part 2b of the imprint template 2 is transferred to the surface of the pattern inspection member 100. That is, the pattern provided in the inspection object 1 is transferred to the surface of the pattern inspection member 100. Furthermore, the reference mark 102 described later is transferred to the surface of the pattern inspection member 100.

Thus, the pattern inspection member 100 includes a component pertaining to photosensitivity or thermosensitivity (photosensitive component or thermosensitive component).

As described later, the pattern inspection member 100 is mechanically stretched. The pattern inspection member 100 is mechanically stretched so as not to distort the feature of the transferred pattern, defect, and reference mark.

Thus, the pattern inspection member 100 further includes a component pertaining to stretching and a component pertaining to feature retention of the pattern.

That is, the pattern inspection member 100 is shaped like a film and includes a component pertaining to photosensitivity or thermosensitivity, a component pertaining to stretching, and a component pertaining to feature retention of the pattern.

The component pertaining to photosensitivity or thermosensitivity can be e.g. a photosensitive resin or thermosensitive resin.

The photosensitive resin or thermosensitive resin can be e.g. a liquid silicone resin. The liquid silicone resin can be configured to include e.g. silicone polymer, silsesquioxane or the like.

Alternatively, the photosensitive resin or thermosensitive resin can be e.g. a liquid in which norbornene resin or oxazole resin used as a raw material of cycloolefin polymer or a block copolymer of amic acid and silicone resin is dissolved in a solvent.

Alternatively, the photosensitive resin or thermosensitive resin can be configured to include e.g. an artificial cartilage material, soft diamond gel (tetra-polyethylene glycol gel) or the like.

The component pertaining to stretching can be e.g. a thermoplastic resin including no cyclic structure. The thermoplastic resin including no cyclic structure can be e.g. PMMA (polymethyl methacrylate), PE (polyethylene), PP (polypropylene), PVA (polyvinyl alcohol), PA (polyamide), POM (polyoxymethylene) or the like.

The component pertaining to feature retention of the pattern can be e.g. a thermoplastic resin including a cyclic structure. The thermoplastic resin including a cyclic structure can be e.g. COP (cycloolefin polymer), PC (polycarbonate), PS (polystyrene), PET (polyethylene terephthalate), AS (acrylonitrile styrene), ABS (acrylonitrile butadiene styrene) or the like.

Here, if the amount of the component pertaining to photosensitivity or thermosensitivity is small, transfer failure of the pattern, defect and the like may increase. Thus, preferably, the component pertaining to photosensitivity or thermosensitivity is included in 5 wt % or more.

If the amount of the component pertaining to stretching is small, it may be impossible to increase the stretching ratio of the pattern inspection member 100. Thus, preferably, the component pertaining to stretching is included in 30 wt % or more.

If the amount of the component pertaining to feature retention of the pattern is small, the feature of the pattern, defect and the like is distorted when the pattern inspection member 100 is stretched. Thus, preferably, the component pertaining to feature retention of the pattern is included in 5 wt % or more.

For instance, the pattern inspection member 100 can be configured to include the component pertaining to photosensitivity or thermosensitivity in 20 wt %, the component pertaining to stretching in 70 wt %, and the component pertaining to feature retention of the pattern in 10 wt %.

The proportion of the component pertaining to photosensitivity or thermosensitivity, the component pertaining to stretching, and the component pertaining to feature retention of the pattern can be determined by previously performing experiments and the like.

Next, the pattern inspection method is described.

As shown in FIG. 2, the inspection object 1 is held so as to be opposed to the pattern inspection member 100. At this time, the side of the inspection object 1 provided with the metal film is opposed to the pattern inspection member 100.

The inspection object 1 is held so that a prescribed distance is provided between the metal film 3 and the pattern inspection member 100.

The distance between the metal film 3 and the pattern inspection member 100 can be appropriately changed depending on e.g. the intensity of near-field light 200a described later, and the proportion of the component pertaining to photosensitivity or thermosensitivity.

The distance between the metal film 3 and the pattern inspection member 100 can be determined by previously performing experiments and the like. The distance is considered to be approximately 100 nm at the maximum.

Alternatively, the metal film 3 and the pattern inspection member 100 may be brought into contact with each other.

Here, at the time of pattern transfer, if the metal film 3 or the protrusion 2b1 is inserted into the pattern inspection member 100, the transferred pattern may be distorted, for instance, and extracted as a defect. That is, false detection of a defect may occur.

In the pattern inspection method according to this embodiment, a prescribed distance is provided between the metal film 3 and the pattern inspection member 100, or the metal film 3 and the pattern inspection member 100 is brought into contact with each other.

This can suppress that the transferred pattern is distorted, for instance, and extracted as a defect.

Subsequently, the surface 2a1 of the inspection object 1 on the opposite side from the side provided with the metal film 3 is irradiated with infrared radiation 200.

The infrared radiation 200 introduced in the inspection object 1 propagates inside the inspection object 1 and generates near-field light 200a on the side of the inspection object 1 provided with the metal film 3.

At this time, near-field light 200a is generated from the neighborhood of each end part of a plurality of metal films 3.

On the other hand, the size of the pattern formed in the imprint template 2 (e.g., the pitch dimension of the protrusions 2b1) is as small as approximately 10-20 nm. Thus, infrared radiation is not emitted from between the protrusions 2b1.

Accordingly, near-field light 200a is generated in a region corresponding to the pattern feature of the imprint template 2.

Furthermore, near-field light 200a is generated also in the mark part 4.

The mark part 4 is provided in the peripheral region surrounding the pattern region in which a plurality of protrusions 2b1 are provided.

When the pattern inspection member 100 is irradiated with the near-field light 200a, the component pertaining to photosensitivity (photosensitive component) included in the pattern inspection member 100 is photosensitized and causes composition change.

Thus, the pattern formed in the imprint template 2 is transferred to the pattern inspection member 100 to form a pattern 101.

Furthermore, the mark formed in the mark part 4 is transferred to the pattern inspection member 100 to form a reference mark 102.

That is, as shown in FIGS. 3A and 3B, a pattern 101 and a reference mark 102 are transferred to the surface of the pattern inspection member 100.

Furthermore, for instance, if a defect 103 such as an open defect 103a and a short defect 103b exists in the pattern formed in the imprint template 2, the defect 103 is also transferred to the surface of the pattern inspection member 100.

For instance, as shown in FIG. 3B, an open defect 103a or short defect 103b is transferred to the surface of the pattern inspection member 100.

Here, the type of the defect 103 is not limited to the open defect 103a and the short defect 103b.

As described above, the pattern inspection member 100 includes a component pertaining to photosensitivity. This can facilitate transfer of the pattern 101, the defect 103, and the reference mark 102.

Here, the pattern 101 and the defect 103 transferred to the surface of the pattern inspection member 100 have nearly the same size as the pattern and the defect in the imprint template 2.

That is, the size of the pattern 101 and the defect 103 is approximately 10-20 nm.

Such fine patterns 101 and defects 103 are extremely difficult to detect directly by an optical defect inspection apparatus.

Thus, in the pattern inspection method according to this embodiment, as shown in FIGS. 4A and 4B, the pattern inspection member 100 is stretched to expand the pattern 101 and the defect 103.

First, the pattern inspection member 100 is softened by heating.

At this time, heating is performed to the extent that the pattern inspection member 100 is softened and that the feature of the pattern 101 and the defect 103 transferred thereto is not distorted.

As described above, the pattern inspection member 100 includes a component pertaining to feature retention of the pattern. Thus, the pattern 101 and the defect 103 also include the component pertaining to feature retention of the pattern. This can suppress distortion of the feature of the pattern 101 and the defect 103 by heating.

Next, a mechanical external force is applied to the pattern inspection member 100 to stretch the pattern inspection member 100.

As described above, the pattern inspection member 100 includes a component pertaining to stretching. Thus, the pattern inspection member 100 can be easily stretched.

Furthermore, the pattern 101 and the defect 103 also include the component pertaining to stretching. Thus, the pattern 101 and the defect 103 are also stretched.

Furthermore, the pattern 101 and the defect 103 also include the component pertaining to feature retention of the pattern. This can suppress distortion of the feature of the pattern 101 and the defect 103 by stretching.

The stretching ratio is not particularly limited. Stretching can be performed so as to enable defection of defects by the optical defect inspection apparatus.

The stretching ratio can be set to e.g. approximately 1.2-2 times.

Furthermore, the direction of stretching is also not particularly limited.

For instance, the pattern inspection member 100 may be stretched in one direction. Alternatively, as shown in FIGS. 4A and 4B, the pattern inspection member 100 may be stretched in two orthogonal directions. Alternatively, the pattern inspection member 100 may be stretched in three or more directions.

In the case where the pattern inspection member 100 is stretched in a plurality of directions, the pattern inspection member 100 may be simultaneously stretched in a plurality of directions, or sequentially stretched in each direction.

The method for mechanical stretching is also not particularly limited.

For instance, the pattern inspection member 100 can be rotated and stretched in a plurality of directions. Alternatively, the pattern inspection member 100 can be held at the periphery and the like, and stretched in one direction or a plurality of directions.

Next, the pattern of the stretched pattern inspection member 100 is inspected.

In this case, an optical defect inspection apparatus can be used to inspect e.g. the presence or absence of defects.

The optical defect inspection apparatus scans the surface of the pattern inspection member 100 and extracts defects.

The optical defect inspection apparatus can be configured to include e.g. a light source such as a mercury lamp and argon laser, a condenser lens, an XY-stage for mounting the pattern inspection member 100, an objective lens, and an image sensor.

The XY-stage moves the pattern inspection member 100 in two horizontal axial directions (XY-directions). The image sensor can be e.g. a CCD sensor in which CCD (charge coupled devices) are arranged in one or two dimensions.

Extraction of defects 103 can be performed by comparison between the patterns transferred to the pattern inspection member 100, or comparison of the pattern in the reference data created from design data and the like with the pattern transferred to the pattern inspection member 100.

That is, extraction of defects 103 can be performed by the die-to-die method, die-to-database method and the like.

As described above, in the case where the size of the defect 103 such as an open defect 103a and short defect 103b is 20 nm or less, the defect 103 is difficult to extract by the optical defect inspection apparatus.

In the pattern inspection method according to this embodiment, the defect 103 is expanded by stretching the pattern inspection member 100. This facilitates extracting the defect 103 by the optical defect inspection apparatus.

In the case where a defect 103 is found, the position of the defect 103 in the imprint template 2 is calculated from the position of the defect 103 in the stretched pattern inspection member 100 and the stretching ratio of the pattern inspection member 100.

The position of the defect 103 in the stretched pattern inspection member 100 can be determined with reference to the reference mark 102.

The stretching ratio of the pattern inspection member 100 can be calculated from the dimension of the reference mark 102 in the pattern inspection member 100 before stretching and the dimension of the reference mark 102 in the stretched pattern inspection member 100.

Here, the stretching ratio of the pattern inspection member 100 can also be calculated from the dimension of an arbitrary reference pattern in the imprint template 2 and the dimension of the reference pattern in the stretched pattern inspection member 100.

The dimension of the reference pattern is e.g. the line width of a line pattern, the hole diameter of a hole pattern, or the distance between two alignment marks.

In the case where a defect 103 is extracted by the optical defect inspection apparatus, it is possible to perform defect review using a SEM (scanning electron microscope) and repair of the defect 103 using an electron beam repair apparatus.

The above example has been illustrated in the case of determining the presence or absence of the defect 103 and the position of the defect 103. However, it is also possible to determine the dimension of the defect 103 and the shape of the defect 103.

The pattern inspection method according to this embodiment can extract even a fine defect 103 that cannot be directly extracted by an optical defect inspection apparatus.

### Second Embodiment

Next, a pattern inspection member 100a and a pattern inspection method according to a second embodiment are illustrated.

In the stretching of the pattern inspection member 100a according to the second embodiment, the pattern inspection member 100a is stretched by swelling the pattern inspection member 100a by absorption of a liquid. In addition, the pattern inspection member 100a in the swollen state may be further mechanically stretched.

The pattern inspection member 100a includes a component pertaining to photosensitivity or thermosensitivity, a component pertaining to feature retention of the pattern, and a component pertaining to swelling.

The component pertaining to photosensitivity or thermosensitivity and the component pertaining to feature retention of the pattern can be made similar to those described above.

In this case, the component pertaining to feature retention of the pattern also serves to suppress shrinkage of the pattern inspection member 100a when the absorbed liquid is evaporated.

The component pertaining to swelling can be a component swollen by absorbing a liquid.

The component pertaining to swelling can be e.g. PMMA (polymethyl methacrylate), PU (polyurethane), fluororesin, PVA (polyvinyl alcohol) or the like. Alternatively, the component pertaining to swelling can be e.g. norbornene resin, oxazole resin or the like used as a raw material of cycloolefin polymer.

Alternatively, the component pertaining to swelling can be e.g. an artificial cartilage material, soft diamond gel (tetra-polyethylene glycol gel) or the like. Soft diamond gel has an expansion ratio as large as 100-1000%. Thus, the stretching ratio can be increased. Soft diamond gel is easy to handle because of its small variation in expansion ratio.

The liquid absorbed in the component pertaining to swelling is an organic solvent or water.

An organic solvent is used in the case of the component pertaining to swelling other than soft diamond gel described above. Water is used in the case of soft diamond gel.

The organic solvent can be HFP (hexafluoropropylene), OFP (octafluoropentanol), TFP (tetrafluoropropanol), HFE (hydrofluoroether), IPA (isopropyl alcohol), PGMEA, anisole, NMP (N-methyl-2-pyrrolidone) or the like.

Alternatively, it is also possible to use a condensed liquid of a gas such as PFP (pentafluoropropane), HFC (hydrofluorocarbon), and nitrogen.

Here, if the amount of the component pertaining to photosensitivity or thermosensitivity is small, transfer failure of the pattern, defect and the like may increase. Thus, preferably, the component pertaining to photosensitivity or thermosensitivity is included in 20 wt % or more.

If the amount of the component pertaining to feature retention of the pattern is small, the feature of the pattern, defect and the like is distorted when the pattern inspection member 100a is stretched. Thus, preferably, the component pertaining to feature retention of the pattern is included in 5 wt % or more.

If the amount of the component pertaining to swelling is small, it may be impossible to increase the stretching ratio of the pattern inspection member 100a. Thus, preferably, the component pertaining to swelling is included in 30 wt % or more.

For instance, the pattern inspection member 100a can be configured to include the component pertaining to photosensitivity or thermosensitivity in 40 wt %, the component pertaining to feature retention of the pattern in 10 wt %, and the component pertaining to swelling in 50 wt %.

The proportion of the component pertaining to photosensitivity or thermosensitivity, the component pertaining to feature retention of the pattern, and the component pertaining to swelling can be determined by previously performing experiments and the like.

Compared with the pattern inspection method described above, the pattern inspection method according to the second embodiment is different in the step of stretching the pattern inspection member 100a.

First, as in the method described above, a pattern 101, a defect 103, a reference mark 102 and the like are transferred to the pattern inspection member 100a.

Next, the pattern inspection member 100a is stretched by swelling.

For instance, the pattern inspection member 100a is immersed in an organic solvent or water stored in a container. Thus, the pattern inspection member 100a is swollen.

For instance, the pattern inspection member 100a is housed in a chamber. The chamber is supplied with a gas such as PFP, HFC, and nitrogen. The internal pressure of the chamber is raised to condense the gas into a liquid. Thus, the pattern inspection member 100a is swollen by absorption of the liquid.

The pattern inspection member 100a is stretched by swelling. The pattern inspection member 100a can be further stretched by applying a mechanical external force to the pattern inspection member 100a.

The stretching ratio, the stretching direction, and the method for mechanical stretching can be made similar to those described above.

In this case, the mechanical stretching apparatus can be provided inside the container storing the organic solvent or water, or the chamber in which the gas is condensed.

Next, as in the method described above, an optical defect inspection apparatus is used to inspect e.g. the presence or absence of defects.

In this case, the presence or absence of a defect, the position of the defect, the dimension of the defect, the shape of the defect, for instance, can be inspected inside the container storing the organic solvent or water, or the chamber in which the gas is condensed.

Alternatively, the presence or absence of a defect, the position of the defect, the dimension of the defect, the shape of the defect, for instance, can be inspected outside the container storing the organic solvent or water, or the chamber in which the gas is condensed.

The liquid is evaporated when the pattern inspection member 100a is taken out from the container storing the organic solvent or water, or the chamber in which the gas is condensed. However, the pattern inspection member 100a includes a component pertaining to feature retention of the pattern. This can suppress shrinkage of the pattern inspection member 100a due to evaporation of the liquid.

### Third Embodiment

Next, a pattern inspection member 100b and a pattern inspection method according to a third embodiment are illustrated.

In the stretching of the pattern inspection member 100b according to the third embodiment, the pattern inspection member 100b includes a component pertaining to foaming. Heating, pressurization, or light irradiation is performed on the pattern inspection member 100b including the component pertaining to foaming to generate foam inside the pattern inspection member 100b. Thus, the pattern inspection member 100b is stretched by foaming. In addition, the pattern inspection member 100b with the foam generated therein may be further mechanically stretched.

The pattern inspection member 100b includes a component pertaining to photosensitivity or thermosensitivity, a component pertaining to stretching, a component pertaining to feature retention of the pattern, and a component pertaining to foaming.

The component pertaining to photosensitivity or thermosensitivity, the component pertaining to stretching, and the component pertaining to feature retention of the pattern can be made similar to those described above.

The component pertaining to foaming can be e.g. an azo compound.

Here, if the amount of the component pertaining to photosensitivity or thermosensitivity is small, transfer failure of the pattern, defect and the like may increase. Thus, preferably, the component pertaining to photosensitivity or thermosensitivity is included in 20 wt % or more.

If the amount of the component pertaining to stretching is small, it may be impossible to increase the stretching ratio of the pattern inspection member 100b. Thus, preferably, the component pertaining to stretching is included in 30 wt % or more.

If the amount of the component pertaining to feature retention of the pattern is small, the feature of the pattern, defect and the like is distorted when the pattern inspection member 100b is stretched. Thus, preferably, the component pertaining to feature retention of the pattern is included in 5 wt % or more.

If the amount of the component pertaining to foaming is small, foam is not sufficiently generated inside the pattern inspection member 100b. This may suppress expansion of the pattern inspection member 100b. Thus, preferably, the component pertaining to foaming is included in 5 wt % or more.

For instance, the pattern inspection member 100b can be configured to include the component pertaining to photosensitivity or thermosensitivity in 40 wt %, the component pertaining to stretching in 45 wt %, the component pertaining to feature retention of the pattern in 10 wt %, and the component pertaining to foaming in 5 wt %.

The proportion of the component pertaining to photosensitivity or thermosensitivity, the component pertaining to stretching, the component pertaining to feature retention of the pattern, and the component pertaining to foaming can be determined by previously performing experiments and the like.

Compared with the pattern inspection method described above, the pattern inspection method according to the third embodiment is different in the step of stretching the pattern inspection member 100b.

First, as in the method described above, a pattern 101, a defect 103, a reference mark 102 and the like are transferred to the pattern inspection member 100b.

Next, foam is generated inside the pattern inspection member 100b. Thus, the pattern inspection member 100b is stretched by foaming.

For instance, the pattern inspection member 100b is heated, pressurized, or irradiated with light. Thus, foam is generated inside the pattern inspection member 100b.

The pattern inspection member 100b is stretched by foaming. The foamed pattern inspection member 100b can be further stretched by applying a mechanical external force to the pattern inspection member 100b.

The stretching ratio, the stretching direction, and the method for mechanical stretching can be made similar to those described above.

Next, as in the method described above, an optical defect inspection apparatus is used to inspect e.g. the presence or absence of defects.

### Fourth Embodiment

Next, a pattern inspection member 100c and a pattern inspection method according to a fourth embodiment are illustrated.

In the stretching of the pattern inspection member 100c according to the fourth embodiment, a gas is injected into the pattern inspection member 100c. Thus, the pattern inspection member 100c is stretched by expansion due to the injection of the gas. In addition, the pattern inspection member 100c with the gas injected therein may be further mechanically stretched.

The pattern inspection member 100c includes a component pertaining to photosensitivity or thermosensitivity, a component pertaining to stretching, and a component pertaining to feature retention of the pattern.

The component pertaining to photosensitivity or thermosensitivity, the component pertaining to stretching, and the component pertaining to feature retention of the pattern can be made similar to those described above.

Here, if the amount of the component pertaining to photosensitivity or thermosensitivity is small, transfer failure of the pattern, defect and the like may increase. Thus, preferably, the component pertaining to photosensitivity or thermosensitivity is included in 20 wt % or more.

If the amount of the component pertaining to stretching is small, it may be impossible to increase the stretching ratio of the pattern inspection member 100c. Thus, preferably, the component pertaining to stretching is included in 30 wt % or more.

If the amount of the component pertaining to feature retention of the pattern is small, the feature of the pattern, defect and the like is distorted when the pattern inspection member 100c is stretched. Thus, preferably, the component pertaining to feature retention of the pattern is included in 5 wt % or more.

For instance, the pattern inspection member 100c can be configured to include the component pertaining to photosensitivity or thermosensitivity in 40 wt %, the component pertaining to stretching in 50 wt %, and the component pertaining to feature retention of the pattern in 10 wt %.

The proportion of the component pertaining to photosensitivity or thermosensitivity, the component pertaining to stretching, and the component pertaining to feature retention of the pattern can be determined by previously performing experiments and the like.

Compared with the pattern inspection method described above, the pattern inspection method according to the fourth embodiment is different in the step of stretching the pattern inspection member 100c.

First, as in the method described above, a pattern 101, a defect 103, a reference mark 102 and the like are transferred to the pattern inspection member 100c.

Next, a gas is injected into the pattern inspection member 100c. Thus, the pattern inspection member 100c is stretched by expansion due to the injection of the gas. In addition, the pattern inspection member 100c with the gas injected therein may be further mechanically stretched.

Before injecting the gas, the pattern inspection member 100c can be softened by heating.

The injected gas only needs to be less prone to reaction with the pattern inspection member 100c. The injected gas can be e.g. nitrogen gas, helium gas, argon gas or the like.

The stretching ratio, the stretching direction, and the method for mechanical stretching can be made similar to those described above.

Next, as in the method described above, an optical defect inspection apparatus is used to inspect e.g. the presence or absence of defects.

### Fifth Embodiment

Next, transfer to the pattern inspection member 100 (100a-100c) according to a fifth embodiment is illustrated.

In the transfer to the pattern inspection member 100 (100a-100c) described above, the pattern inspection member 100 (100a-100c) is irradiated with infrared radiation through the inspection object 1.

In contrast, in the transfer to the pattern inspection member 100 (100a-100c) according to this embodiment, the pattern inspection member 100 (100a-100c) is partly heated through the inspection object 1.

For instance, the pattern inspection member 100 (100a-100c) is irradiated with far infrared radiation through the inspection object 1.

As shown in FIG. 2, the distance from the top surface of the protrusion 2b1 to the pattern inspection member 100 (100a-100c) is shorter than the distance from the surface between the protrusions 2b1 to the pattern inspection member 100 (100a-100c).

Thus, the region corresponding to the patter feature of the imprint template 2 is heated in the pattern inspection member 100 (100a-100c). Accordingly, the pattern, defect and the like are transferred to the pattern inspection member 100 (100a-100c).

### Sixth Embodiment

Next, a pattern inspection apparatus 300 is illustrated.

The pattern inspection apparatus 300 can perform the pattern inspection method described above.

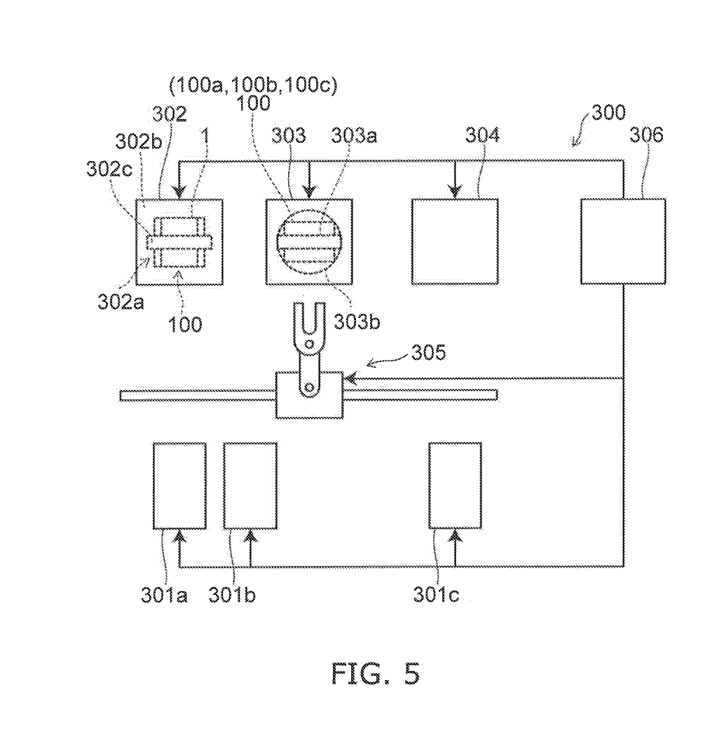

FIG. 5 is a layout diagram for illustrating the pattern inspection apparatus 300.

As shown in FIG. 5, the pattern inspection apparatus 300 includes housing sections 301a, 301b, 301c, a transfer section 302, a stretching section 303, an inspection section 304, a transport section 305, and a control section 306.

The housing section 301a houses a plurality of inspection objects 1 in the stacking direction. The housing section 301a changes the position of the inspection object 1 in the stacking direction.

The housing section 301b houses a plurality of pattern inspection members 100 (100a-100c) in the stacking direction. The housing section 301b changes the position of the pattern inspection member 100 (100a-100c) in the stacking direction. The housing section 301b houses the pattern inspection members 100 (100a-100c) before transfer of patterns, defects and the like.

The housing section 301c houses a plurality of inspected pattern inspection members 100 (100a-100c) in the stacking direction. The housing section 301c changes the position of the inspected pattern inspection member 100 (100a-100c) in the stacking direction.

The transfer section 302 transfers a pattern 101, a defect 103, and a reference mark 102 of the inspection object 1 to the surface of the pattern inspection member 100 (100a-100c).

The transfer section 302 includes e.g. a mounting section 302a, a holding section 302b, and an irradiation section 302c.

The mounting section 302a includes e.g. a vacuum chuck and holds the pattern inspection member 100 (100a-100c) mounted thereon.

The holding section 302b includes e.g. a mechanical chuck and holds the inspection object 1. The holding section 302b holds the inspection object 1 so that a prescribed distance is provided between the metal film 3 of the inspection object 1 and the pattern inspection member 100 (100a-100c). Alternatively, the holding section 302b holds the inspection object 1 so that the metal film 3 of the inspection object 1 and the pattern inspection member 100 (100a-100c) are in contact with each other.

The irradiation section 302c applies light or heat to the surface of the pattern inspection member 100 (100a-100c) through the inspection object 1. The irradiation section 302c can include e.g. an infrared lamp or far infrared lamp.

The stretching section 303 stretches the pattern inspection member 100 (100a-100c) to which the pattern 101, the defect 103 and the like are transferred.

In the case of stretching the pattern inspection member 100 (100a-100c) by heating the pattern inspection member 100 (100a-100c) and applying a mechanical external force to the pattern inspection member 100 (100a-100c), the stretching section 303 includes a heating device 303a and a stretching device 303b.

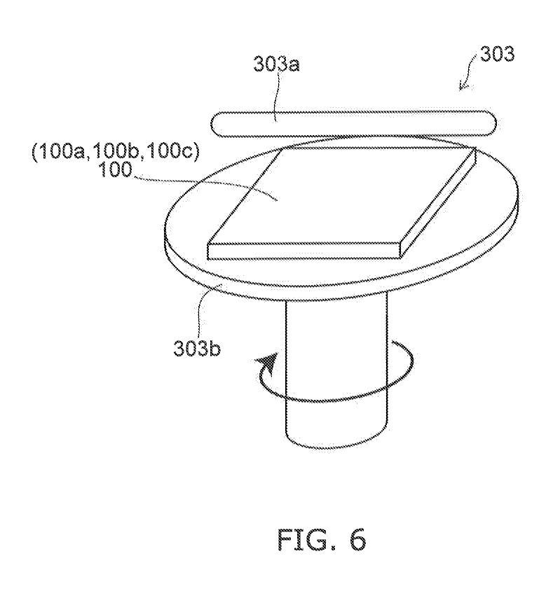

FIG. 6 is a schematic perspective view for illustrating the stretching section 303.

As shown in FIG. 6, the stretching section 303 includes a heating device 303a and a stretching device 303b.

The heating device 303a is e.g. a far infrared heater.

The stretching device 303b includes e.g. a rotary table for rotating the pattern inspection member 100 (100a-100c) mounted thereon.

The configuration of the stretching section 303 is not limited to that illustrated above. The stretching section 303 only needs to be able to stretch the pattern inspection member 100 (100a-100c) by heating the pattern inspection member 100 (100a-100c) and applying a mechanical external force to the pattern inspection member 100 (100a-100c).

In the case of stretching the pattern inspection member 100 (100a-100c) by swelling by absorption of a liquid, the stretching section 303 includes e.g. a container storing a liquid such as an organic solvent and water, or a chamber in which a gas is condensed into a liquid.

In the case of stretching the pattern inspection member 100 (100a-100c) by generating foam therein, the stretching section 303 includes a device for performing heating, pressurization, or light irradiation on the pattern inspection member 100 (100a-100c).

In the case of injecting a gas into the pattern inspection member 100 (100a-100c) and stretching the pattern inspection member 100 (100a-100c) by expansion due to the injection of the gas, the stretching section 303 includes a device for injecting a gas into the pattern inspection member 100 (100a-100c).

The inspection section 304 inspects e.g. the presence or absence of defects in the stretched pattern inspection member 100 (100a-100c).

The inspection section 304 can be an optical defect inspection apparatus including e.g. a light source such as a mercury lamp and argon laser, a condenser lens, an XY-stage for mounting the pattern inspection member 100 (100a-100c), an objective lens, and an image sensor.

The transport section 305 transports the inspection object 1 and the pattern inspection member 100 (100a-100c). For instance, the transport section 305 transports the inspection object 1 between the housing section 301a and the transfer section 302. For instance, the transport section 305 transports the pattern inspection member 100 (100a-100c) between the housing section 301b and the transfer section 302, between the transfer section 302 and the stretching section 303, between the stretching section 303 and the inspection section 304, and between the inspection section 304 and the housing section 301c. The transport section 305 can be e.g. a transport robot.

The control section 306 controls the operation of various elements provided in the housing sections 301a, 301b, 301c, the transfer section 302, the stretching section 303, the inspection section 304, and the transport section 305.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A pattern inspection member to which a pattern provided in an inspection object is transferred, comprising:
a component pertaining to photosensitivity or thermosensitivity;
a component pertaining to stretching; and
a component pertaining to feature retention of the pattern,
the component pertaining to photosensitivity or thermosensitivity including a photosensitive resin or a thermosensitive resin,
the component pertaining to stretching including a thermoplastic resin including no cyclic structure, and
the component pertaining to feature retention of the pattern including a thermoplastic resin including a cyclic structure.

2. The member according to claim 1, further comprising:
a component pertaining to foaming including an azo compound.

3. The member according to claim 1, wherein the photosensitive resin or the thermosensitive resin includes at least one selected from the group consisting of silicone resin, norbornene resin, oxazole resin, a block copolymer of amic acid and silicone resin, an artificial cartilage material, and soft diamond gel.

4. The member according to claim 1, wherein the thermoplastic resin including no cyclic structure includes at least one selected from the group consisting of PMMA (polymethyl methacrylate), PE (polyethylene), PP (polypropylene), PVA (polyvinyl alcohol), PA (polyamide), and POM (polyoxymethylene).

5. The member according to claim 1, wherein the thermoplastic resin including a cyclic structure includes at least one selected from the group consisting of COP (cycloolefin polymer), PC (polycarbonate), PS (polystyrene), PET (polyethylene terephthalate), AS (acrylonitrile styrene), and ABS (acrylonitrile butadiene styrene).

6. The member according to claim 1, wherein the component pertaining to photosensitivity or thermosensitivity is included in 5 wt % or more.

7. The member according to claim 1, wherein the component pertaining to stretching is included in 30 wt % or more.

8. The member according to claim 1, wherein the component pertaining to feature retention of the pattern is included in 5 wt % or more.

9. A pattern inspection member to which a pattern provided in an inspection object is transferred, comprising:
a component pertaining to photosensitivity or thermosensitivity;
a component pertaining to feature retention of the pattern; and
a component pertaining to swelling,
the component pertaining to photosensitivity or thermosensitivity including a photosensitive resin or a thermosensitive resin,
the component pertaining to feature retention of the pattern including a thermoplastic resin including a cyclic structure, and
the component pertaining to swelling including at least one selected from the group consisting of PMMA (polymethyl methacrylate), PU (polyurethane), fluororesin, PVA (polyvinyl alcohol), norbornene resin, oxazole resin, an artificial cartilage material, and soft diamond gel.

10. The member according to claim 9, wherein the photosensitive resin or the thermosensitive resin includes at least one selected from the group consisting of silicone resin, norbornene resin, oxazole resin, a block copolymer of amic acid and silicone resin, an artificial cartilage material, and soft diamond gel.

11. The member according to claim 9, wherein the thermoplastic resin including a cyclic structure includes at least one selected from the group consisting of COP (cycloolefin polymer), PC (polycarbonate), PS (polystyrene), PET (polyethylene terephthalate), AS (acrylonitrile styrene), and ABS (acrylonitrile butadiene styrene).

12. The member according to claim 9, wherein the component pertaining to photosensitivity or thermosensitivity is included in 20 wt % or more.

13. The member according to claim 9, wherein the component pertaining to feature retention of the pattern is included in 5 wt % or more.

14. The member according to claim 9, wherein the component pertaining to swelling is included in 30 wt % or more.

15. A pattern inspection method comprising:
transferring a pattern provided in an inspection object to the pattern inspection member according to claim 1;
stretching the pattern inspection member to which the pattern is transferred; and
inspecting the pattern of the stretched pattern inspection member.

16. The method according to claim 15, wherein
the inspection object includes a protrusion projected from a base part and a metal film provided on a top surface of the protrusion, and
in the transferring a pattern, light is applied toward the inspection object, and transfer is performed by near-field light emitted from a side of the inspection object provided with the metal film.

17. The method according to claim 15, wherein in the transferring a pattern, transfer is performed by partly heating the pattern inspection member through the inspection object.

18. A pattern inspection apparatus comprising:
a transfer section configured to transfer a pattern provided in an inspection object to the pattern inspection member according to claim 1;
a stretching section configured to stretch the pattern inspection member to which the pattern is transferred; and
an inspection section configured to inspect the pattern of the stretched pattern inspection member.

19. The apparatus according to claim 18, wherein
the inspection object includes a protrusion projected from a base part and a metal film provided on a top surface of the protrusion, and
the transfer section applies light toward the inspection object, and performs transfer by near-field light emitted from a side of the inspection object provided with the metal film.

20. The apparatus according to claim 18, wherein the transfer section performs transfer by partly heating the pattern inspection member through the inspection object.
